(19) United States
(12) Patent Application Publication
(10) Pub. No.: US 2004/0123234 A1
(43) Pub. Date: Jun. 24, 2004

(54) Method and system for change control management of shema definition objects

(75) Inventors: Breanna Daphne Anderson, Bothell, WA (US); Andrei Ovchinnikov, Redmond, WA (US)

Correspondence Address: MERCHANT & GOULD PC, P.O. BOX 2903, MINNEAPOLIS, MN, 55402-0903, US

(73) Assignee: SchemaLogic, Inc., Redmond, WA (US)

(21) Appl. No.: 10/360,266

(22) Filed: Feb. 6, 2003

Related U.S. Application Data
(60) Provisional application No. 60/434,535, filed on Dec. 18, 2002.

(51) Int. Cl. G06F 17/21

(52) U.S. Cl. 715/513

(57) ABSTRACT

The present invention provides a method and system for change control management of schema definition objects across disparate systems. A determination is made when a proposed change associated with an object is made; an impact analysis is performed on the proposed change; the change is implemented when the impact analysis indicates that there is no impact on, other system stakeholders otherwise: a change object based on the proposed change is created, voting rights are allocated to users based on the impact analysis; and the proposed change is accepted or canceled in response to the voting. Change control contracts may be associated with the objects. The contracts may be customized to establish change management rules for and enterprise and to specialize rules for certain objects or branches of a Content Class tree corresponding to a department or a discipline. The access to changing the contracts may also be limited to help ensure that the contracts are not bypassed.

### RELATED APPLICATION

This application claims the benefit of U.S. Provisional Application No. 60/434,535, filed Dec. 18, 2002, the benefit of the earlier filing date of which is hereby claimed under 35 U.S.C. § 119 (e).

### FIELD OF THE INVENTION

The present invention is related to software, and more specifically to change control contracts across disparate software systems.

### BACKGROUND OF THE INVENTION

Attempts to access and share information across disparate systems are limited by inconsistent organizational naming and data standards. It is very difficult to have a collaborative software infrastructure to create information access and sharing standards across existing systems by managing disparate taxonomies and metadata models.

Many technologies have tried to solve basic information integration problems, but have not had great success. Deployments of integration technologies have not measured up to their intended return in part because the technology relies on organizational standards to be well adopted and assumes that naming standards are unchanging.

In reality, standards rarely exist, have limited adoption, and are subject to change. What is needed is a way to solve the problem of creating and maintaining disparate systems using schema objects.

### SUMMARY OF THE INVENTION

Briefly described, the present invention is directed at providing a method and system for change control management of schema definition objects across disparate systems.

According to aspects of the invention, a determination is made when a proposed change associated with an object is made; an impact analysis is performed on the proposed change; the change is implemented when the impact analysis indicates that there is no impact on the objects, otherwise: a change object based on the proposed change is created, voting rights are allocated to users based on the impact analysis; and the proposed change is accepted or canceled in response to the voting.

According to another aspect of the invention, levels of permission are associated with the objects. For example, the levels of permission may indicate the actions that may be performed on the object by a particular user.

According to another aspect of the invention, change control contracts may be associated with the objects. The contracts may be customized to establish change management rules for an enterprise and to specialize rules for certain objects or branches of a Content Class tree corresponding to a department or a discipline. The access to changing the contracts may also be limited to help ensure that the contracts are not bypassed. The contracts are inherited down a vocabulary tree.

According to yet another aspect of the invention, when performing the impact analysis on the proposed change a contract that is the most relevant to the object with the proposed change is found. The most relevant contract may be the contract with the closest proximity to the object. The creation time of the contract may be used to aid in the determination of proximity.

According to still yet another aspect of the invention, a determination is made as to what objects and users are affected by the proposed change.

### BRIEF DESCRIPTION OF THE DRAWINGS

FIGS. 1-3 show components of an exemplary environment in which the invention may be practiced;

FIG. 4 illustrates a change workflow;

FIG. 5 illustrates an exemplary contract;

FIG. 6 shows an overview change process;

FIG. 7 shows illustrative examples;

FIG. 8 illustrates a visual illustration of the object relationships; and

FIG. 9 illustrates an example of an impact assessment, according to aspects of the invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected or an indirect connection through one or more passive or active intermediary devices.

Impact Analysis/Contract-based Change Control

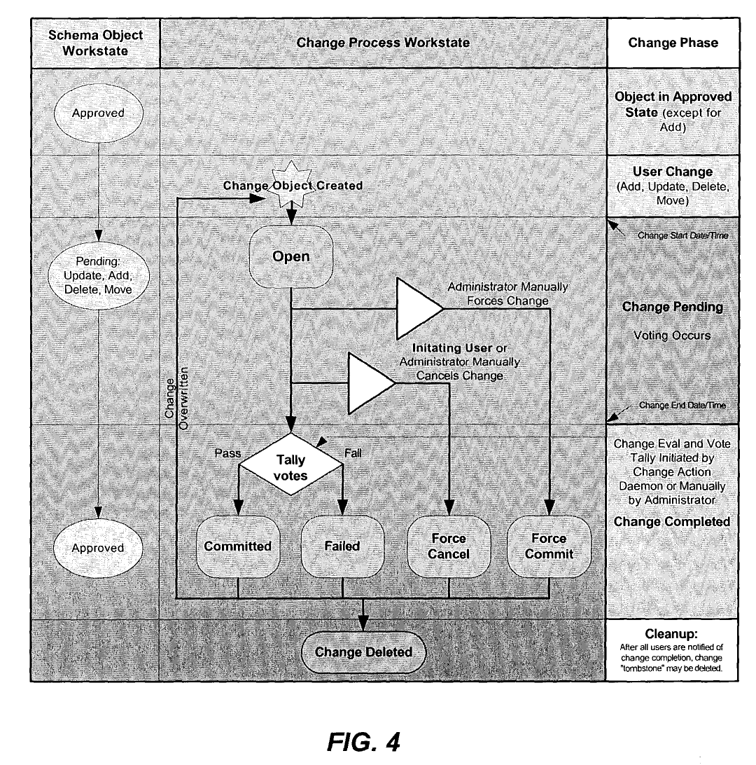

FIG. 4 illustrates a change workflow, in accordance with aspects of the invention. As shown in the figure, the change workflow includes an object workstate, a change process workstate, and a change phase.

The object workstate illustrates five change phases, including the object being in an approved state; a user change phase; a change pending phase; a change completed phase; and a cleanup phase.

The phase moves to a change pending phase once the user initiates a change and a change object is created. During the change pending state, voting occurs which decides whether the change object will be accepted. During the change pending phase, the status of the affected objects is in a pending state. While the object is in the pending state, no changes to the system are made. When it is determined whether to make the change or not, the process moves to a change completed phase.

Unless an approved user forces the change, the votes are tallied to determine whether to initiate the change. The vote may indicate that the change was accepted (committed) or failed. The phase then moves to a cleanup phase, where after all users are notified of the change completion the change object is deleted. At this point, the phase returns to an approved state phase.

Inter-schema object class Impact analysis combined with Contract/role based change control provides powerful and customizable workflow management for metaschema objects. The contract/role based workflow helps to enable workable enterprise collaboration and notification for metaschema management.

User Permissions and Roles

Registered users of the system may be granted different levels of permission to the schema objects. According to one embodiment of the invention, three levels of permission to certain classes of Metashema Objects may be provided to a user. The following table illustrates exemplary levels of permission.

| | |
|---|---|
| Owner | An object owner can update and delete the object. If |
| | the object is a Term or ContentClass, the owner may |
| | also update and delete and add sub-Terms or sub- |
| | Classes respectively. |
| Stakeholder | An object stakeholder is allowed to vote on changes |
| | submitted to that object. |
| Subscriber | An object subscriber is given advance notification |
| | when changes are submitted and committed to that |
| | object. |

The objects that can be “owned” include: Vocabularies; Terms; ElementTypes; and ContentClasses. Ownership of Vocabulary and ElementType classes confer rights to add instances of these objects.

The owners of the objects (or system administrators) are allowed rights to initiate an update, deletion or other modification to the owned object or its descendents. When a data modifying operation is performed, a sequence of events is activated to ensure that all affected parties are involved in the appropriate way.

Contracts control the change control process. A contract specifies the rules and schedule on which changes take place. The change control process is designed to provide for adequate notification process and to provide adequate notification period for all impacted objects users and groups.

A contract is associated with an object that may be changed and includes the following information, according to one embodiment of the invention:

| Contract Part | Description |
|---|---|
| Embargo period | The number of days between the submission of the |
| | change and its implementation or cancellation |
| | (dependent on voting). |
| Voting Rules | Matrix specifying the voting method used: (approve, |
| | veto) based on owner role: (owner, stakeholder) |
| | and type of operation: (add, update, delete) |
| ImplementASAP | If true, once all votes are in, if it passes, the change is |
| | implemented immediately. Otherwise the change waits |
| | till the embargo period closes. |

According to one embodiment, voting methods include approve, veto, and no vote.

Contract rules for Vocabularies/Terms:

Contracts inherit down a vocabulary tree. In case of multiple vocabulary inheritance and conflicting contracts, the closest contract (in terms of relationship steps away) takes precedent. In case of a tie, the most recently added takes precedent.

Contracts for child classes are cloned from the parent contract at creation time but may be modified thereafter.

General Change Management workflow process:

The owner of an object may perform a data modifying operation at any time. Upon execution of the data modifying operation, it is determined if the change will be implemented immediately or deferred pending a change control process. If an object is newly added and changes to it do not affect other objects with different owners in the system, then the changes take effect immediately. If other objects with other owners or if the object being changed has other owners, then the change will be made pending and the following process will begin. The details of the process vary depending on the type of object involved but the general flow is consistent for all objects.

The following is a general flow for an update/delete/modify operation. First an impact assessment is made. When there is no impact the change takes effect immediately. When there is an impact then the change becomes pending and is not implemented immediately. Voting then occurs on the pending change

Different processes within the system are used in the change control process. According to one embodiment of the invention, the processes include the following. The Notification Daemon processes unprocessed votes and changes in process, and mails summary reports to users. The Change Process Daemon scans for completed processes (all votes in or embargo expired) and counts votes and implements or flags changes as failed.

At the time of the data modifying transaction, a quick “Impact Assessment” is performed to determine if the change has an impact on any other controlled object in the system. Newly added objects or objects which have an impact on other objects owned by the same user do not raise an impact assessment and the change is committed to the database and is visible to all users immediately. If an impact is assessed, the change is deferred in various ways depending on the object type and the operation type:

| | Vocabulary | Term | ElementType | ContentClass |
|---|---|---|---|---|
| Add | Flag approved | Flag pending add | Flag approved | Flag approved |
| | | (AddVocTerm) | | |
| Update | Cache update and | Cache update | Cache update | Cache update |
| | flag pending | and flag | and flag | and flag |
| | update | pending | pending update | pending update |
| | | update | | |
| Delete | Flag pending | occurs | Flag pending | Flag pending |
| | delete | following | delete | delete |
| | | orphaning | | |
| AddTermRel | Flag termrel | N/a | N/a | N/a |
| | pending add | | | |
| DelTermRel | Flag termrel | N/a | N/a | N/a |
| | Pending delete | | | |
| MoveTermRek | Flag old termrel | N/a | N/a | N/a |
| | pending delete, | | | |
| | Flag new termrel | | | |
| | pending add | | | |

Rules for Objects in Pending States

According to one embodiment, 1-degree versioning is implemented. The user may choose the mode of either seeing all pending changes or seeing the approved objects.

The addition of new objects is used for vocabulary tree structures and submitted updates to content classes that add or remove class/element associations. If a user wishes to see authorized data, all objects (and relationships) flagged “Pending Add” are ignored.

Users who wish to see the pending updated value of an object ask for the updated value. The cached update value is returned to the user in place of the actual committed data.

Generally, Change Control Contracts (CCCs) may be used to fine-tune the Change management rules for Terms, Vocabularies, Vocabulary Views Elements and Content Classes. The contracts may be customized to establish the overall default change management rules for the enterprise and to specialize rules for certain objects or branches of the Content Class tree corresponding to a department or discipline.

To help ensure that Contracts are not used to bypass regular Change management processes, access to adding, removing, and updating contracts is limited. According to one embodiment, only Administrators may add, remove or update contracts. The Contract conceptually is an agreement between the owner of the object or the administrators and the users who subscribe directly or indirectly to an object on the ground rules for change management.

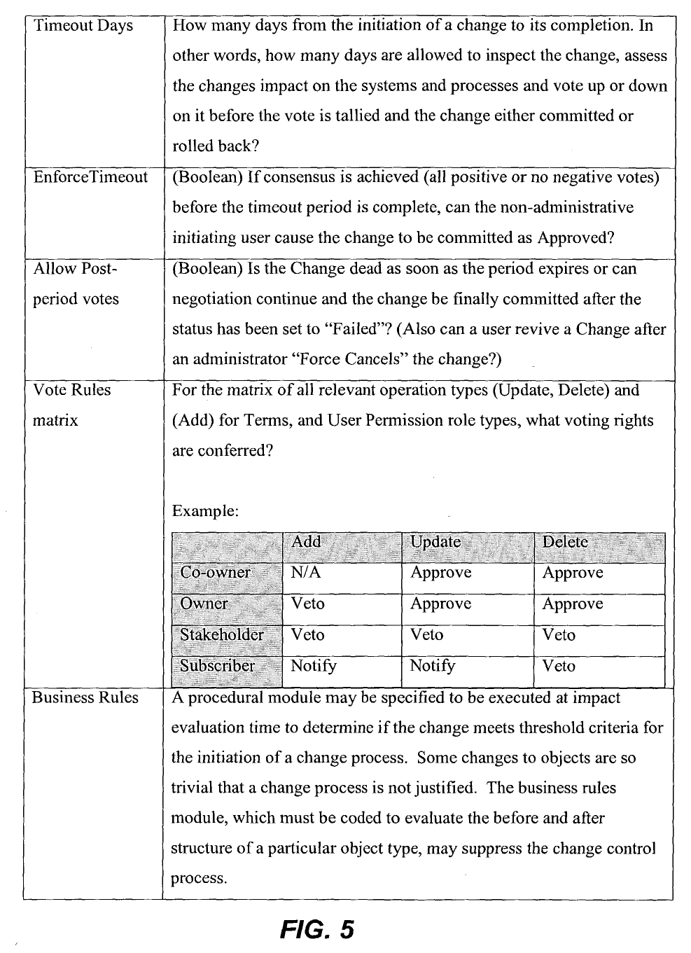

FIG. 5 illustrates an exemplary contract, according to aspects of the invention. Timeout Days refers to how many days from the initiation of a change to its completion. In other words, how many days are allowed to inspect the change, assess the changes impact on the systems and processes and vote up or down on it before the vote is tallied and the change either committed or rolled back?

EnforceTimeout is a Boolean value that refers to If consensus is achieved (all positive or no negative votes) before the timeout period is complete, can the non-administrative initiating user cause the change to be committed as Approved?

Allow Post-period votes is a Boolean value that refers to is the Change dead as soon as the period expires or can negotiation continue and the change be finally committed after the status has been set to “Failed.”

The Vote Rules matrix refers to the matrix of all relevant operation types (Update, Delete) and (Add) for Terms, and User Permission role types, what voting rights are conferred? An example is:

| | Add | Update | Delete |
|---|---|---|---|
| Co-owner | N/A | Approve | Approve |
| Owner | Veto | Approve | Approve |
| Stakeholder | Veto | Veto | Veto |
| Subscriber | Notify | Notify | Veto |

The Voting Rights (or Voting Rules) matrix allows system administrators, or other qualified users, to control the allocation of voting rights based on the combination of the type of change and the maximum permission role that a participating user has on all objects impacted in a change.

Choosing Timeout Days

The Timeout Days parameter of the Contract specifies the normal period in days between the initiation of a change and its completion and either commitment or failure. The more users or systems impacted or the more complex or less flexible the impacted systems, the longer the period required for consideration and preparation for a pending change.

A Contract closely associated with the changed object, for example a Vocabulary Term, may prevail in the negotiation but impacted Content Classes downstream, that most closely represent impacted systems, may have Contracts that stipulate extended timeout periods. Consequently, the Timeout Days for a Change is the Maximum of all the encountered Contracts, including the best-matching Content Class Contract.

Contract Business Rules provide a powerful mechanism for filtering out “Change Noise” that can desensitize an organization to important changes and reduce overall participation when it counts. If every punctuation change to every description of every object is brought up for a vote, frustration can be expected to mount.

Business rules are procedural logic modules that can be attached to contracts to filter out changes that the threshold necessary to justify a Change process and consensus voting. Sample, generic Business rules may be supplied that may be attached to Contracts. For example, the business rule may be used to suppress Change control processes (i.e. immediately save objects) when changes are made only to description or notes properties for all Objects. New Business rules may be easily customized and installed within the server to meet the particular business rules of any enterprise or group. Business rules simply compare the original and changed structure of the object being updated and return a logical flag indicating whether Change control should be invoked or whether the change is below the threshold and should simply be immediately committed.

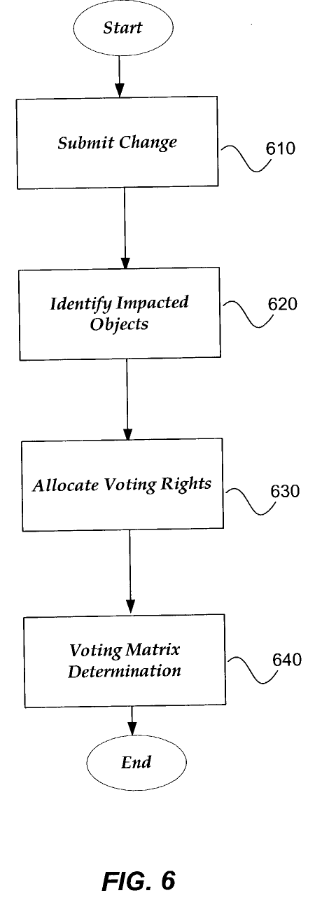

FIG. 6 shows an overview change process, in accordance with aspects of the invention. After a start block, the process flows to block 610, where a change is submitted to the SchemaServer. Flowing to block 620, the impact analysis logic identifies all impacted objects and all users who have any kind of permission relating to those objects (e.g. Owner, Stakeholder or Subscriber). Transitioning to block 630 each impacted user is allocated voting rights based on the highest level of permission they have to any impacted object. For example, if they are an owner of an Element definition, but a Stakeholder for an impacted Content Class, then the User is granted voting rights as an “Owner.” Once the standing of the user has been established, the process flows to block 640 where the voting right granted to them for the Change process is determined by the matrix. The process then ends and returns to processing other actions.

The default intent of the permission roles of Owner, Stakeholder and Subscriber are generally followed to retain a consistency across the system. For example, allocating Approve rights to Subscribers is rarely, if ever, justified just as allocating “No-Vote” (notify only) rights to Owners undercuts the principle of consensus development.

Co-owners are users who have ownership permission to the object that was updated or deleted. Co-owners may be established either to act as a check on other owners or they may work very closely with other co-owners primarily for load-sharing. In the latter case, allocation of Veto or even No-Vote (notify) voting rights to co-owners may be appropriate, while Approve vote rights may be more appropriate in the former situation.

According to one embodiment of the invention, the user who initiates the change, whether an administrator or a regular object owner, never receives a vote.

“Owners” are users who have ownership permission to any object that is impacted by a change other than the object itself. This allows different voting dynamics to be established for peer owners of an object than for owners of indirectly impacted objects potentially far removed.

Contract Negotiation

Contracts may be attached to many objects within the system with the intent of that Contract having force whenever a change is made to that object or changes are made to objects that impact that object, (but do not have their own overriding contract.)

For example, if the users who share a given Vocabulary wish to establish special, more or less rigorous contract rules than the norm whenever changes are made to that vocabulary, they may arrange for a special Contract to be attached. Changes made to any Terms (additions, updates or deletes) will use the parameters of the Contract for that vocabulary.

Since a Contract is not attached to every object in the system, the principle of contract negotiation is to find the contract that is most relevant to the object being changed. Relevance is assessed by finding the contract most closely linked to the changed object. Proximity is determined by following the impact analysis path from the object changed through all objects impacted. The first impacted object with a Contract is selected. In some cases, however, the impact analysis path branches and Contracts may “tie” for proximity. In this case, the Date/Time of creation of the contract may be used as a tie-breaker.

According to one embodiment, the foregoing rule applies to changes to Terms, Vocabularies, Vocabulary Views and Elements.

If the change is to a ContentClass, or if no Contract is encountered for any of the above Objects, the rules change to reflect the inheritance of Contracts down the Content Class tree.

If the change is made directly to a Content Class or if it affects only one Content Class the logic is simple: Trace up the tree toward the root until a Contract is encountered.

As such, the Root Class has an associated Contract that serves as the default contract for the system. If contracts are specialized on lower Content Classes, those contracts will have force in their sub-branches of the tree until overridden by a Contract associated with a yet-lower Content Class.

What happens when an Object such as an Element is changed that impacts multiple Content Classes? For example, the element “Income” is referenced immediately by classes in both the “Finanance” and “CustomerProfiles” branches of the Content Class tree. Each branch has its own Contract governing Change process rules.

Contract negotiation rules specify that the classes that are the common ancestors of all impacted classes are searched for contracts from the bottom up until a Contract is identified. Each Class in the upper Class tree should contain a Contract that is mutually agreeable to the managers of all lower classes. In general, it is assumed that consequently the higher classes may have more stringent contract conditions.

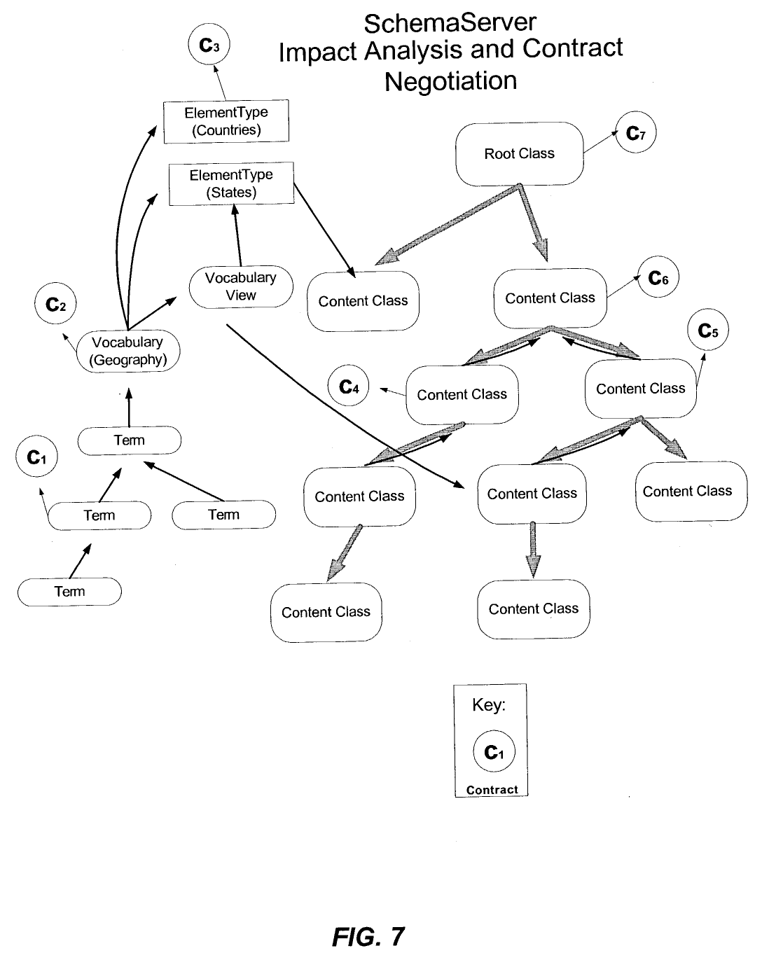

FIG. 7 shows illustrative examples, in accordance with aspects of the invention.

Example 1. All contracts C1 through C7 are in force. If a change is made to the bottom term of the vocabulary, C1 is the prevailing contract.

Example 2. If contract C1 is removed and the bottom Term is updated, Contract C2 is the prevailing contract.

Example 3. If Contracts C1 through C3 are removed and any term in the vocabulary is updated, the vocabulary, two elements and in turn two classes will be impacted. Though Contracts C4 and C5 are “closer”, Contract C6 is selected as the closest common contract between the two branches.

Impact Analysis Rules

According to one embodiment, schema information is maintained in a dynamic database of virtual objects and inter-object references. The highest-level construct is a Content Class. According to one embodiment, creatable Content Class structures may be subscribed to by clients and downloaded in XML format to control schema structures on client, subscriber systems.

Content Classes are built up of lower-level objects (other classes, ElementTypes, Vocabularies, Vocabulary Filters and Terms. Changes to any of those lower level objects indirectly change the overall definition of the Content Class i.e. the Class Schema. Impact analysis logic traces the relationships up the impact tree from any individual object to all impacted objects to drive the change management process. API and Administrative User interfaces also allow the impact analysis logic to be run in anticipation of a change so that a user may evaluate the impact of a change before committing it.

Two impact analysis methods will now be described. EvalObjectImpact returns a list of all objects impacted by a proposed change. EvalUserImpact returns a list of users who will be impacted by virtue of their ownership, subscribership or stakeholdership of any of the impacted objects. In the impact logic detail below, we will specify only the rules for assessing object impacts. User impacts are determined by first assessing the object impacts and then joining this object list with permissions against those objects to render a list of impacted users.

The Impact Analysis Chain

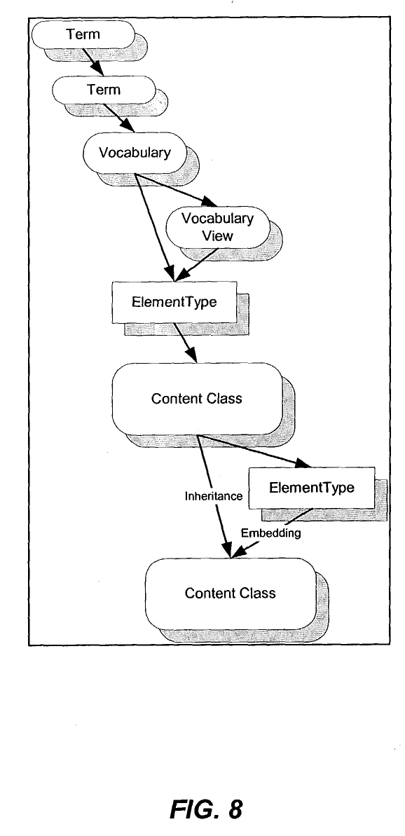

Impacts are evaluated in a chain based upon the relationships and interdependencies between the objects. Impact analysis begins with a reference to an individual object. Impacts are assessed against objects of the same type (in the case of Terms) and to all objects of the next type in the chain. See FIG. 8 for a visual illustration of the object relationships. Impact analysis can begin at any point in the chain: i.e. with a Term, Vocabulary, VocabularyView, ElementType or ContentClass.

The impact assessment process is repeated at each level (each type of Schema Object) until all ContentClass impacts are evaluated.

Term Impacts

Terms are chained together to form vocabularies through TermRelationship objects. A Term may be used in multiple vocabularies. When a vocabulary is created, a “Root Term” is created for that vocabulary and all other terms in that vocabulary are linked to it through TermRelationships.

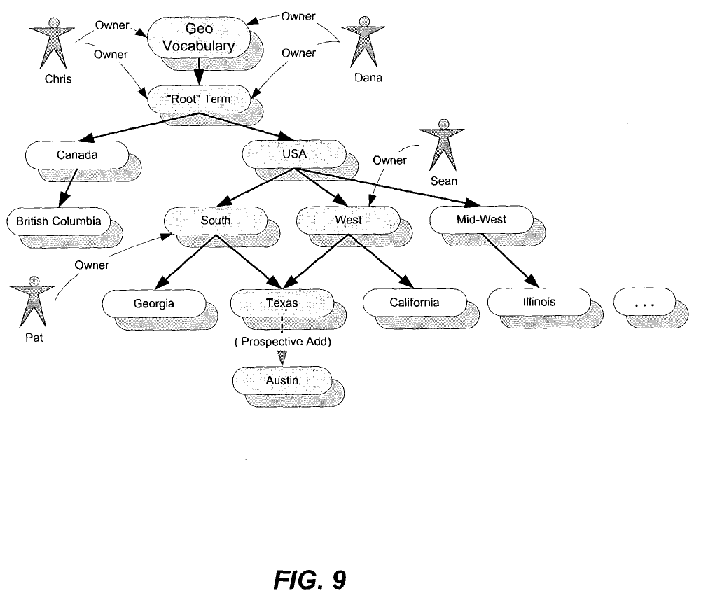

For terms, impacts are assessed up the tree from the term in question to the root term of the vocabulary. FIG. 9 illustrates an example of an impact assessment, in accordance with aspects of the invention. The example illustrates an impact assessment on a prospective Add of the term “Austin” beneath the term “Texas” in a poly-hierarchical vocabulary of geographical terms. Impacts are assessed up the tree in this manner because owners or stakeholders of “upstream” terms are included on any changes that impact their domain.

Referring to FIG. 9, if Chris, a vocabulary co-owner, wants to add the term “Austin” beneath the term “Texas”, Chris may run an “Add/Remove” impact analysis on the term Texas to determine that the terms “Root”, USA, South, and West will be impacted and Pat, Sean and Dana will need to vote on such a change. Pat is the guardian of the definition of the “South” geography terms, Sean is the overseer of the definition of “West” geography terms, and Dana has overall responsibility for the Geography vocabulary.

If Chris proceeds to add the term, the impact analysis will be run automatically and all impacted users will be granted Votes associated with the Change control process.

Depending on what kind of term/vocabulary operation is performed, the precise rules of impact analysis vary. Below is a discussion of the variation of rules based on the operation type:

Add Term

When adding a term to a vocabulary, all of the terms on the path from the parent term to the root are impacted. The vocabulary being added to is also impacted.

Update Term

When updating a term, all paths from the updated term to the root in every vocabulary in which the term appears are assessed as impacted. All vocabularies in which the term appears are impacted. Because vocabularies may share terms, this cross-vocabulary impact is taken into account. The single-point management of terms across vocabularies can be powerful but the additional cost of maintaining consensus should be understood.

Remove Term

When removing a term from a vocabulary (Delete), all term relationships that associate that term in that vocabulary are removed. The impact of removing a term is essentially the same as that of adding a new child term: All terms on all paths from that term to the root are impacted.

If the term being removed does not appear in any other vocabulary, the term may optionally be deleted from the system. See description on Orphan Term management below.

If a term has child terms in this vocabulary, those child terms are removed from the vocabulary. Impact is not assessed on these child terms. The owner of the term in question and the “upstream” terms are assumed to have the necessary purview to determine the correctness of such an operation. The vocabulary being removed from is impacted.

Remove Term Relationship

In a simple hierarchical vocabulary (where every term has one and only one parent, the removal of an inbound term relationship is equivalent to complete removal of the term from the vocabulary. However, in a poly-hierarchical vocabulary, such as in FIG. 9, the removal of an individual term relationship may result with the term remaining in the vocabulary. For example, if the owner of the “South” vocabulary tree determined that “Texas” was not a true southern state, they could remove that single relationship, leaving the relationship to “West” intact.

In this particular exemplary case, the impact is assessed against the term relationship that joins “South” with “Texas”. All terms from the parent term “South” to the root of the vocabulary are assessed as impacted plus the term “Texas” itself is impacted. The term “West” is not impacted so it will not be given a vote on this operation. The vocabulary being removed from is impacted.

Delete Term

A term may be deleted from the system as a result of a Remove (from vocabulary) operation if the “delete orphans” option is selected. If the term is left as an orphan in the system (it does not belong to any vocabulary, but could be subsequently added to a vocabulary), it may be explicitly deleted using the Administrative Control Panel. No impacts are assessed in this case.

Move Term

A Move Term operation is deconstructed into a transactional “Add Term Relationship” and “Delete Term Relationship” operation. Impacts are assessed accordingly to each sub-operation.

Vocabulary Impacts

When a user is granted permission to a Vocabulary, they are also granted permission to the root term of the vocabulary so that the user has purview over all term-level changes in the vocabulary. A change to any term as detailed above is impacted as a change on the vocabulary. The vocabulary has a few header properties, (name, and description), that may be updated by the vocabulary owner. Though this usually has little impact on higher-level objects, an impact is assessed nonetheless.

Either an update or delete to a vocabulary is assessed in the same manner. All ElementTypes and all Vocabulary Views that make reference to the vocabulary are impacted. Addition of new vocabularies does not cause an impact. A vocabulary may not be deleted until all references to it are removed.

Though a vocabulary view may reference a subset of a vocabulary by specifying a starting Term, all changes to the vocabulary are currently assessed to the vocabulary view. If the vocabulary view filter specifies a starting term, the owner of the vocabulary view should be added with owner, stakeholder or subscriber rights as appropriate, to that term.

Vocabulary View Impacts

Updates to Vocabulary Views impact ElementTypes that reference that Vocabulary View. Deletes to Vocabulary views impact ElementTypes that reference that Vocabulary View. Addition of Vocabulary views does not cause an impact

Element Type Impacts.

Element types define simple or complex data fields for use in Content Classes. Data types may be simple scalars: Strings, Numbers, Boolean values or Dates. Since these ElementTypes make reference to no other Schema Objects, no impacts are assessed against these ElementTypes. An update to an ElementType impacts all ContentClasses that immediately reference it. All classes that inherit from those classes are also impacted as discussed in the following section. Addition of new ElementTypes does not cause an impact. An ElementType may not be removed from the system until all immediate class references to it are removed.

Content Class Impacts

Content Classes are arranged in a simple, single-inheritance hierarchy. Unlike Terms in vocabularies where impacts flow up the tree to the root, impacts flow down the class tree from a class to the inheriting classes. Changes to classes down the tree (farther from the root and closer to the leaves) never have an impact on parent classes. However, structure changes to a class inherit down to child and descendant classes and consequently pose impacts to those classes.

Some classes do not stand alone as description for metadata or schema structures but form a sub-structure of a schema, for example, the structure of an address: (Street1, Street2, Unit, City, State, Country, PostalCode, AddressType). Such a sub-structure of, say, a list of Addresses may be “embedded” in another class by referencing the Address class from an ElementType called “Addresses”. The “Addresses” ElementType is consequently impacted by any change to the definition of that Content Class. Update of a ContentClass causes impacts on all descendant classes that inherit from it. Update of a ContentClass also causes impacts on all ElementTypes that reference it.

When evaluating impacts on ElementTypes and ContentClasses, impact assessment continues iteratively alternately between ElementTypes and ContentClasses until no further impacts are found on either so that all impacts of both embedding and inheritance are included. The potential for recursion is accounted for. Addition of new Content Classes does not cause impacts because a new class does not have children. A content class is not deleted unless it has no child classes and is not referenced by any ElementTypes.

Rules for Granting of Votes

According to one embodiment, impact analysis can be performed manually by users before any actual update operation is attempted. Both the object and user impacts are performed and displayed for the user's inspection. When an actual operation is performed, however, the system assesses only the user impacts since the purpose is to determine who, if anyone is to be consulted.

If no users other than the acting user are impacted, no workflow process is invoked and the operation is immediately implemented. If one or more other users are impacted, even if they have notification only (no vote) rights by virtue of a “subscriber” permission to some very indirectly-impacted object, the workflow process is begun so that the constituency represented by that users has the chance to prepare organizationally and/or technically for the impending change.

The user is granted a voting right level depending on the type or permission the user has to an impacted object. According to one embodiment of the invention, the users are granted one of three levels of voting rights, including: approve, veto, and no-vote.

Approve—in order for the change to take place the user must vote yes.

Veto—The change will take place If the user does not vote no.

NoVote—The user does not have a vote, but is notified about the change and the change is tracked in their “My Workspace” area. The user may register comments that can be reviewed by other voting users.

According to one embodiment, a fixed contract for changes to all types of objects is implemented. Following are the rules for granting voting rights:

If a user has permission to multiple impacted objects, they receive voting rights based on the highest level of permission they have (Owner, Stakeholder, Subscriber) in that

| | |
|---|---|
| Co Owners of the object acted upon | Veto* |
| Owner of impacted object | Approve |
| Stakeholder of object or impacted object | Veto |
| Subscriber | NoVote |

*Co-owners are assumed to be for purposes of redundancy so veto rights are granted in case one is unavailable.

The potential impact of the change on a term used in multiple vocabularies, referenced by multiple important element types, referenced by a ContentClass or classes situated high in the content class tree with hundreds of inheriting content classes is substantial. The number of individuals who are consulted with and their level of permission can be tuned and controlled by how liberally permissions are granted and what level of permission are allowed. Changes that have broad impact should reasonably be more difficult to implement by virtue of the potential for organizational disruption. Changes which have little or no impact should and usually can be made quickly or with no workflow process at all.

Exemplary Operating Environment

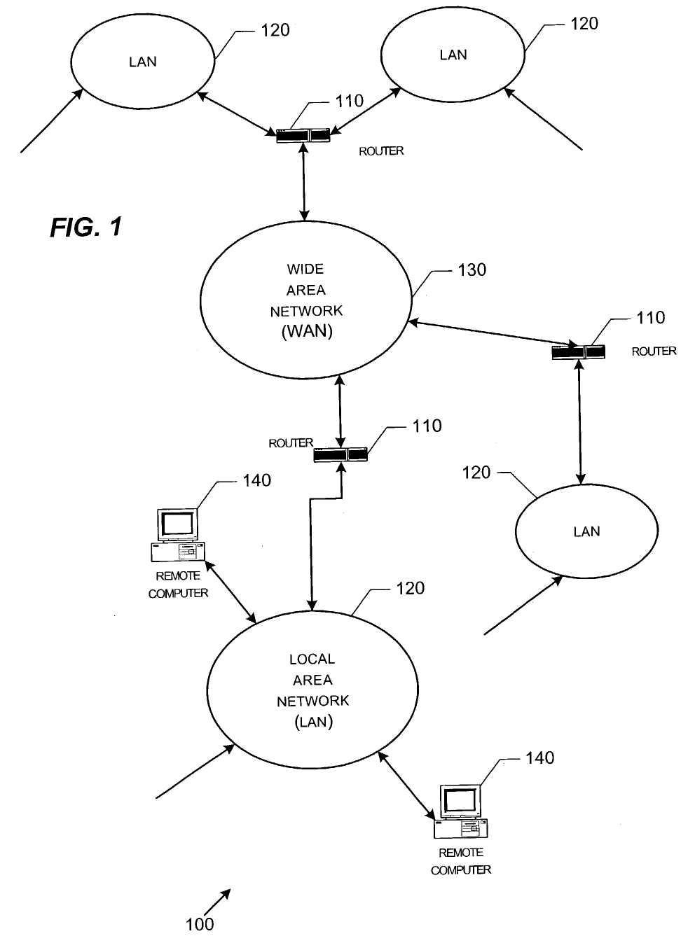

FIGS. 1-3 show components of an exemplary environment in which the invention may be practiced. Not all of the components may be required to practice the invention, and variations in the arrangement and type of the components may be made without departing from the spirit or scope of the invention.

FIG. 1 shows a plurality of local area networks (“LANs”) 120 and wide area network (“WAN”) 130 interconnected by routers 110. On a single network linking many computers through a mesh of possible connections, a router receives transmitted messages and forwards them to their correct destinations over available routes. On an interconnected set of LANs—including those based on differing architectures and protocols—, a router acts as a link between LANs, enabling messages to be sent from one to another. Communication links within LANs typically include twisted pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links known to those skilled in the art. Furthermore, computers, such as remote computer 140, and other related electronic devices can be remotely connected to either LANs 120 or WAN 130 via a modem and temporary telephone link. The number of WANs, LANs, and routers in FIG. 1 may be increased or decreased arbitrarily without departing from the spirit or scope of this invention.

The media used to transmit information in communication links illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

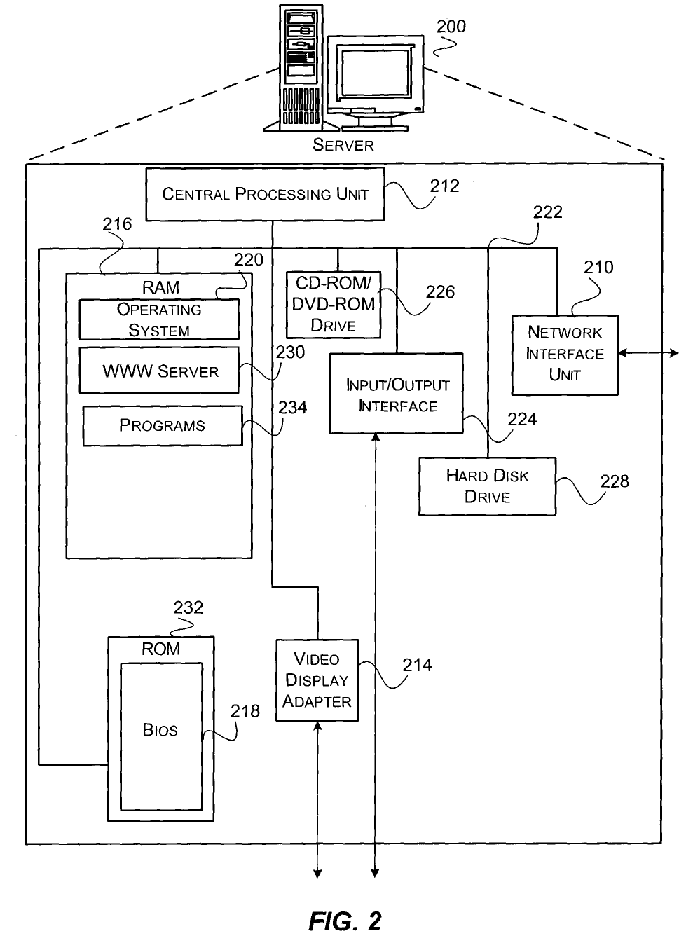

A server, such as the server shown in FIG. 2, may provide a WWW site, be a content server, a schema server, an authentication server, etc.

FIG. 2 shows an exemplary server in accordance with aspects of the invention. Server 200 may include many more components than those shown in FIG. 2. As shown in FIG. 2, server 200 is connected to WAN/LAN 100, or other communications network, via network interface unit 210. Network interface unit 210 includes the necessary circuitry for connecting server 200 to WAN/LAN 100, and is constructed for use with various communication protocols including the TCP/IP protocol. Typically, network interface unit 210 is a card contained within server 200.

Server 200 also includes processing unit 212, video display adapter 214, and a mass memory, all connected via bus 222. The mass memory generally includes random access memory (“RAM”) 216, read-only memory (“ROM”) 232, and one or more permanent mass storage devices, such as hard disk drive 228, a tape drive (not shown), optical drive 226, such as a CD-ROM/DVD-ROM drive, and/or a floppy disk drive (not shown). The mass memory stores operating system 220 for controlling the operation of server 200. This component may comprise a general purpose server operating system as is known to those of ordinary skill in the art, such as UNIX, LINUX™, or Microsoft WINDOWS NT®. Basic input/output system (“BIOS”) 218 is also provided for controlling the low-level operation of server 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory may also store program code and data for providing a WWW site. More specifically, the mass memory may store applications including server application program 230, and programs 234.

Server 200 also comprises input/output interface 224 for communicating with external devices, such as a mouse, keyboard, scanner, or other input devices not shown in FIG. 2. Likewise, server 200 may further comprise additional mass storage facilities such as optical drive 226 and hard disk drive 228. Hard disk drive 228 is utilized by server 200 to store, among other things, application programs, databases, and program data used by server application program 230. For example, schemas, customer databases, product databases, image databases, and relational databases may be stored.

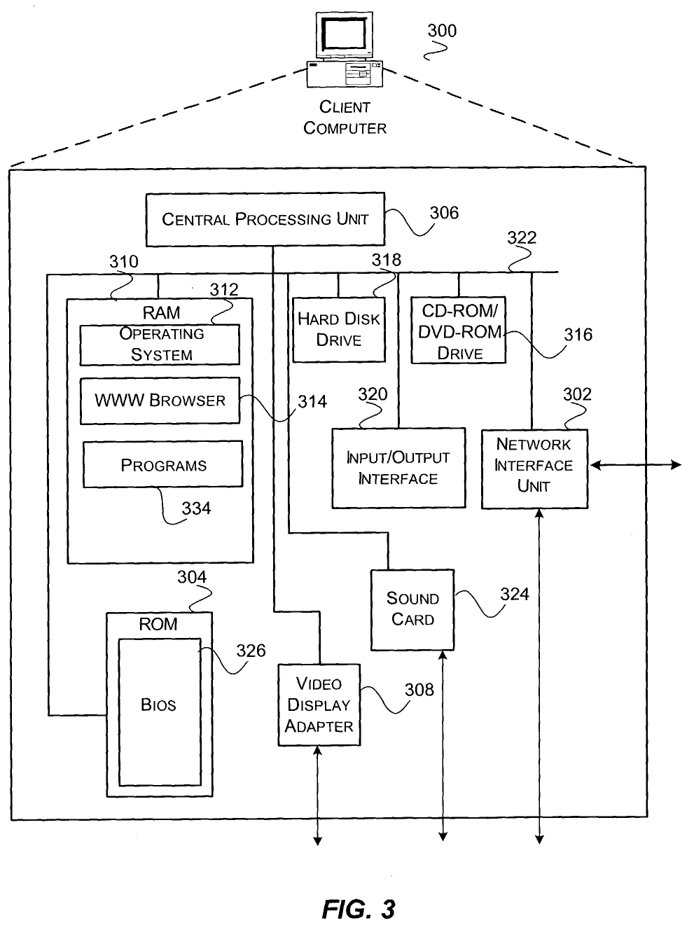

FIG. 3 depicts several components of client computer 300. Client computer 300 may include many more components than those shown in FIG. 3. However, it is not necessary that those conventional components be shown in order to disclose an illustrative embodiment for practicing the present invention. As shown in FIG. 3, client computer 300 includes network interface unit 302 for connecting to a LAN or WAN, or for connecting remotely to a LAN or WAN. Network interface unit 302 includes the necessary circuitry for such a connection, and is also constructed for use with various communication protocols including the TCP/IP protocol, the particular network configuration of the LAN or WAN it is connecting to, and a particular type of coupling medium. Network interface unit 302 may also be capable of connecting to the Internet through a point-to-point protocol (“PPP”) connection or a serial line Internet protocol (“SLIP”) connection as known to those skilled in the art.

Client computer 300 also includes BIOS 326, processing unit 306, video display adapter 308, and memory. The memory generally includes RAM 310, ROM 304, and a permanent mass storage device, such as a disk drive. The memory stores operating system 312 and programs 334 for controlling the operation of client computer 300. The memory also includes WWW browser 314, such as Netscape's NAVIGATOR® or Microsoft's INTERNET EXPLORER® browsers, for accessing the WWW. It will be appreciated that these components may be stored on a computer-readable medium and loaded into memory of client computer 300 using a drive mechanism associated with the computer-readable medium, such as a floppy disk drive (not shown), optical drive 316, such as a CD-ROM/DVD-ROM drive, and/or hard disk drive 318. Input/output interface 320 may also be provided for receiving input from a mouse, keyboard, or other input device. The memory, network interface unit 302, video display adapter 308, and input/output interface 320 are all connected to processing unit 306 via bus 322. Other peripherals may also be connected to processing unit 306 in a similar manner.

As will be recognized from the discussion below, aspects of the invention may be embodied on server 200, on client computer 300, or on some combination thereof. For example, programming steps may be contained in programs 334 and/or programs 234.

In this disclosure, references will be made to client and server. Where appropriate, client should be construed to refer to a process or set of processes that execute on one or more electronic device, such as client computer 300 of FIG. 3. A client is not limited, however, to running on a client computer. It may also run on a server, such as server 200 or be distributed among various electronic devices, wherein each device might contain one or more processes or routines that together constitute a client application. Where appropriate, client should be construed, in addition or in lieu of the discussion above, to be a device upon which one or more client processes execute, for example, client computer 300 or server 200.

Similarly, server should be construed to refer to a process or set of processes that execute on one or more electronic devices, such as server 200. Like a client, a server is not limited to running on a server computer. Rather, it may also execute on what would typically be considered a client computer, such as client computer 300 of FIG. 3, or be distributed among various electronic devices, wherein each device might contain one or more processes or routines that together constitute a server application. Where appropriate, server should be construed, in addition or in lieu of the discussion above, to be a device upon which one or more server processes execute, for example, server 200 or client computer 300.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for change control management of schema definition objects across disparate systems, comprising:
determining when a proposed change associated with an object is made;
performing an impact analysis on the proposed change;
determining when the proposed change does not affect other objects, and when, implementing the change, otherwise:
creating a change object based on the proposed change;
allocating voting rights to users based on the impact analysis and an associated negotiated change contract;
determining when to accept the change based on a voting scheme; and
approving the change when accepted; otherwise canceling the change.

2. The method of claim 1, wherein allocating the voting rights further comprises associating levels of permission to classes of the objects.

3. The method of claim 2, wherein the levels of permission are selected from a set comprising: owner, stakeholder, and subscriber.

4. The method of claim 1, further comprising utilizing change control contracts that are associated with the objects.

5. The method of claim 4, further comprising customizing the contracts to establish change management rules for an enterprise and to specialize rules for certain objects or branches of a Content Class tree corresponding to a department or a discipline.

6. The method of claim 5, further comprising limiting access to customizing the contracts such that the contracts are not bypassed.

7. The method of claim 4, wherein a user may set at least one of the following parameters: a number of timeout days; an enforce timeout parameter; an allow post-period votes parameter; a voting rules matrix, and business rules.

8. The method of claim 2, wherein the voting rights further comprise an approval right, a veto right, and a no vote right.

9. The method of claim 7, wherein the contract inherits down a vocabulary tree.

10. The method of claim 4, wherein performing the impact analysis on the proposed change further comprises finding a contract that is the most relevant to the object with the proposed change.

11. The method of claim 10, wherein finding the contract that is the most relevant further comprises finding the contract with the closest proximity.

12. The method of claim 11, wherein finding the contract with the closest proximity further comprises using the creation time of the contract.

13. The method of claim 1, wherein performing the impact analysis on the proposed change further comprises determining users that are affected by the proposed object change.

14. The method of claim 13, further comprising assessing the proposed change up a tree to a root term of a vocabulary.

15. A system for change control management of schema definition objects across disparate systems, comprising:
a server, comprising:
a network connection configured to communicate with clients;
a memory configured to store resources;
a process configured to perform functions, comprising;
determining when a proposed change associated with an object is made by one of the clients;
performing an impact analysis on the proposed change;
determining when the proposed change does not affect other objects, and when the proposed change does not affect other objects implementing the change, otherwise:
creating a change object based on the proposed change;
allocating voting rights to users based on the impact analysis;
determining when to accept the change based on voting by the clients; and
approving the change when accepted; otherwise canceling the change.
clients, comprising:
a network connection configured to communicate with the server;
a memory configured to store resources; and
a process arranged to receive and send information relating to objects with the server and configured to perform actions, comprising: voting on the proposed change; and proposing a change to an object.

16. The system of claim 15, wherein allocating the voting rights further comprises associating levels of permission to classes of the objects.

17. The system of claim 15, wherein the levels of permission are selected from a set comprising: owner, stakeholder, and subscriber.

18. The system of claim 15, further comprising utilizing change control contracts that are associated with the objects.

19. The system of claim 18, further comprising customizing the contracts to establish change management rules for an enterprise and to specialize rules for certain objects or branches of a Content Class tree corresponding to a department or a discipline.

20. The system of claim 19, further comprising limiting access to customizing the contracts such that the contracts are not bypassed.

21. The system of claim 18, wherein a user may set at least one of the following parameters: a number of timeout days; an enforce timeout parameter; an allow post-period votes parameter; a voting rules matrix, and business rules.

22. The system of claim 16, wherein the voting rights further comprise an approval right, a veto right, and a no vote right.

23. The system of claim 21, wherein the contract inherits down a vocabulary tree.

24. The system of claim 18, wherein performing the impact analysis on the proposed change further comprises finding a contract that is the most relevant to the object with the proposed change.

25. The system of claim 24, wherein finding the contract that is the most relevant further comprises finding the contract with the closest proximity.

26. The system of claim 25, wherein finding the contract with the closest proximity further comprises using the creation time of the contract.

27. The system of claim 15, wherein performing the impact analysis on the proposed change further comprises determining users that are affected by the proposed object change.

28. The system of claim 27, further comprising assessing the proposed change up a tree to a root term of a vocabulary.

29. A system for change control management of schema definition objects across disparate systems, comprising:
means for determining when a proposed change associated with an object is made;
means for performing an impact analysis on the proposed change;
means for determining when the proposed change does not affect other objects, and when, implementing the change, otherwise:
means for creating a change object based on the proposed change;
means for allocating voting rights to users based on the impact analysis;
means for determining when to accept the change based on a voting scheme; and
means for approving the change when accepted; otherwise canceling the change.
